(19) United States
(12) Patent Application Publication
(10) Pub. No.: US 2012/0252505 A1
(43) Pub. Date: Oct. 4, 2012

(54) TABLET TERMINAL AND PORTABLE TERMINAL, AND METHOD FOR ACHIEVING PHONE CALL FUNCTION OF TABLET TERMINAL USING PORTABLE TERMINAL

(75) Inventors: Joon Young JUNG, Daejeon (KR); Jeun Woo Lee, Daejeon (KR)

(73) Assignee: Electronics and Telecommunictions Research Institute, Daejeon (KR)

(21) Appl. No.: 13/438,187

(22) Filed: Apr. 3, 2012

(30) Foreign Application Priority Data
Apr. 4, 2011 (KR) 10-2011-0030757

(51) Int. Cl. H04W 56/00; H04B 7/00; H04W 88/02

(52) U.S. Cl. 455/458; 455/556.1; 455/41.2

(57) ABSTRACT

A method provides achieving a phone call function of a tablet terminal using a portable terminal. The method includes performing synchronization with the portable terminal when the tablet terminal receives a request for a call connection from a wireless network. After making the call connection to the wireless network, the tablet terminal transmit voice signals received from the wireless network to the portable terminal and transmit voice signals generated by the portable terminal to the wireless network. Upon terminating the call connection with the wireless network, the tablet terminal terminates the communication with the portable terminal.

### CROSS-REFERENCE(S) TO RELATED APPLICATION(S)

The present application claims priority under 35 U.S.C. 119 and 35 U.S.C. 365 to Korean Patent Application No. 10-2011-0030757 (filed on Apr. 4, 2011), which is hereby incorporated by reference in its entirety.

### FIELD OF THE INVENTION

The present invention relates to a tablet terminal and a portable terminal, and more particularly, to a tablet terminal and a portable terminal linked via short-range communication, with a capability of providing a phone call function of the tablet terminal using the portable terminal, and method of providing a phone call function of the tablet terminal using the portable terminal.

### BACKGROUND OF THE INVENTION

With the development of mobile communication terminals, a variety of services, in addition to a phone call function, are provided by installing a variety of application soft-wares, as well as offering the data communication function. For example, the mobile communication terminals may include smart-phones.

Smart-phones are convenient to use the phone call function, but are inconvenient to browse the Internet or the like because of their small screen sizes. Due to this reason, large-size tablet terminals or tablet PCs are being developed and come into use.

In contrast, the tablet terminals are convenient to browse the internet, read e-books or the like because their screen is larger than those of smart-phones, but inconvenient for use as a mobile phone because of their large size and heavy weight.

### SUMMARY OF THE INVENTION

In view of the above, the present invention provides a tablet terminal and a portable terminal linked via short-range communication, with a capability of providing a phone call function of the tablet terminal using the portable terminal.

Further, the present invention provides a method of providing a phone call function of the tablet terminal using the portable terminal.

The objects of the present invention are limited thereto, but other objects that are not described above will be apparently understood by those skilled in the art from the following description.

In accordance with a first aspect of the present invention, there is provided a tablet terminal including:

a wireless communication module configured to communicated with a wireless network;

a communication module configured to perform communication with a portable terminal;

a synchronization module configured to perform synchronization with the portable terminal when a request for a call connection is received from the wireless network through the wireless communication module; and

a voice transmission module configured to transmit voice signals provided from the wireless network to the portable terminal and transmit voice signals generated by the portable terminal to the wireless network through the wireless communication module.

In accordance with a second aspect of the present invention, there is provided a portable terminal including:

a communication module configured to perform communication with a tablet terminal;

a synchronization module configured to perform synchronization with the tablet terminal when a request for a call connection is received from a wireless network through the tablet terminal; and

a voice transmission module configured to transmit voice signals generated by the portable terminal to the wireless network through the tablet terminal and transmit voice signals provided from the wireless network through the tablet terminal to a user interface for outputting thereof.

In accordance with a third aspect of the present invention, there is provided a method of achieving a phone call function of a tablet terminal using a portable terminal, the method including:

when the tablet terminal receives a request for a call connection from a wireless network, performing synchronization with the portable terminal;

after making the call connection to the wireless network, transmitting voice signals received from the wireless network through the tablet terminal to the portable terminal and transmitting voice signals generated by the portable terminal to the wireless network through the tablet terminal; and

upon terminating the call connection with the wireless network, terminating the communication with the portable terminal.

In accordance with a fourth aspect of the present invention, there is provided a method of achieving a phone call function of a tablet terminal using a portable terminal, the method including:

when the call connection request is received from the portable terminal, requesting for a call connection with a wireless network through the tablet terminal;

after making the call connection of the tablet terminal with the wireless network, transmitting voice signals generated by the portable terminal to the wireless network through the tablet terminal and transmitting voice signals received from the wireless network to the portable terminal; and

upon terminating the call connection of the tablet terminal with the wireless network, terminating the communication with the portable terminal.

### BRIEF DESCRIPTION OF THE DRAWINGS

The above and other objects and features of the present invention will become apparent from the following description of embodiments, given in conjunction with the accompanying drawings, in which:

FIG. 1 is a block diagram illustrating a system of achieving a phone call function of a tablet terminal using a portable terminal in accordance with an embodiment of the present invention; and

FIG. 2 is a flowchart illustrating a method for achieving a phone call function of a tablet terminal using a portable terminal in accordance with an embodiment of the present invention.

### DETAILED DESCRIPTION OF THE EMBODIMENTS

The advantages and features of the present invention and methods of accomplishing these advantages and features will be clearly understood from the following description of various embodiments taken in conjunction with the accompanying drawings. However, the present invention is not limited to the following description and is intended to cover alternatives, modifications, and equivalents that may be included within the spirit and scope of the invention as defined in the appended claims. It should be noted that the present description of the embodiments is provided to describe and explain, but not limit the invention.

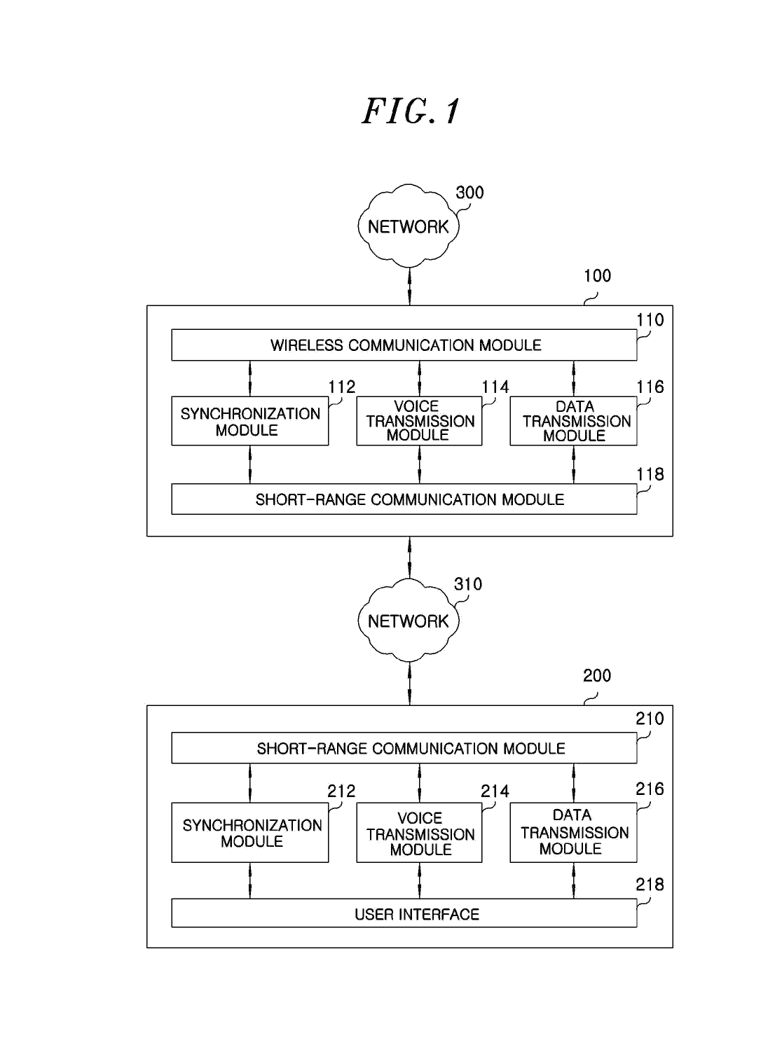

FIG. 1 is a block diagram illustrating a system of achieving a phone call function of a tablet terminal using a portable terminal in accordance with an embodiment of the present invention

The system of the embodiment includes a tablet terminal 100 and a portable terminal 200. The tablet terminal 100, for example, may be a tablet PC that allows a user to receive a voice call service and wireless Internet service through a wireless network 300. The wireless network 300, for example, may include the Internet, Wi-Fi (Wireless Fidelity), 3G or 4G mobile communication networks. The tablet terminal 100 includes a wireless communication module 110, a short-range communication module 118, a synchronization module 112, a voice transmission module 114, and a data transmission module 116.

The wireless communication module 110 may be connected to the wireless network 300 and provide services such as a voice call service, wireless Internet service and the like to the tablet terminal 100 through the wireless network 300.

The short-range communication module 118 performs communication with the portable terminal 200 via a short-range network 310 to make a linkage between the tablet terminal 100 and the portable terminal 200. The short-range communication, for example, may include Bluetooth, ZigBee, WLAN (Wireless Local Area Network), infrared communication, optical wireless communication using a laser, and the like.

A plurality of information is set up in the short-range communication module 118 in advance. The information may include a selection for using portable terminal function indicating that using the portable terminal function is enabled in the tablet terminal 100 and the portable terminal 200, information for an automatic linkage of the tablet terminal 100 and the portable terminal 200, and key values for encrypting data between the tablet terminal 100 and the portable terminal 200. When the other party on the wireless network 300 tries to a call connection with the tablet terminal 100, the short-range communication module 118 links the tablet terminal 100 and the portable terminal 200 based on the set-up information so that a voice communication between the other party and the user of the tablet terminal 100 can be made through the use of the portable terminal 200.

The synchronization module 112 is used for synchronization between the tablet terminal 100 and the portable terminal 200. The synchronization module 112 generates synchronization data, and then transmits it to the portable terminal 200 through the short-range communication module 118 to synchronize the portable terminal 200 with the tablet terminal 100.

The voice transmission module 114 receives voice signals of the other party on the wireless network 300 to which the call connection is made through the wireless communication module 110 and transmits the received voice signals to the portable terminal 200. Further, the voice transmission module 114 transmits voice signals provided from the portable terminal 200 owned by the user to the other party through the wireless communication module 110.

The data transmission module 116 may be connected to the wireless network 300 through the wireless communication module 110 to transmit data received by the wireless communication module 110 from the wireless network 300 to the portable terminal 200 and transmit data received from the portable terminal 200 to the wireless network 300 through the wireless communication module 110. As used herein, the data may be text messages, such as SMS and MMS, and information received via the wireless network 300 or the portable terminal 200.

Meanwhile, the portable terminal 200 includes a short-range communication module 210, a synchronization module 212, a voice transmission module 214, a data transmission module 216, and a user interface 218. The portable terminal 200 may be a dummy terminal having a small size by which the user of the tablet terminal 100 makes a phone call so that the inconvenient due to a large size and heavy weight of the tablet terminal 100 can be mitigate.

The short-range communication module 210 is for performing communication with the short-range communication module 118 of the tablet terminal 100 via the short-range network 310.

During communication with the tablet terminal 100, the synchronization module 212 generates synchronization data, and then transmits the synchronization data to the tablet terminal 100 through the short-range communication module 210. The synchronization data allows that the tablet terminal 100 is synchronized with the portable terminal 200.

The voice transmission module 214 receives the voice signals from the tablet terminal 100 to output the voice signals through the user interface 218. Further, the voice transmission module provides the voice signals generated by the user interface 218 to the tablet terminal 100 through the short-range communication module 210.

The data transmission module 216 receives data that is provided from the tablet terminal 100. Further, the data transmission module 216 provides data that is inputted via the user interface 218 to the tablet terminal 100.

The user interface 218 is used for inputting and outputting the voice signals, texts, messages, and other various types of data. For example, the user interface 218 may include a speaker, a microphone, a keypad, a display device, and so on. More specifically, voice signals that are received from the tablet terminal 100 may be outputted to the speaker, and the voice signals that are inputted through the microphone may be transmitted to the tablet terminal 100 through the voice transmission module 214. Further, data that is inputted through the keypad may be transmitted to the tablet terminal 100 through the data transmission module 216, and data that is received through the data transmission module 216 may be displayed on the display device.

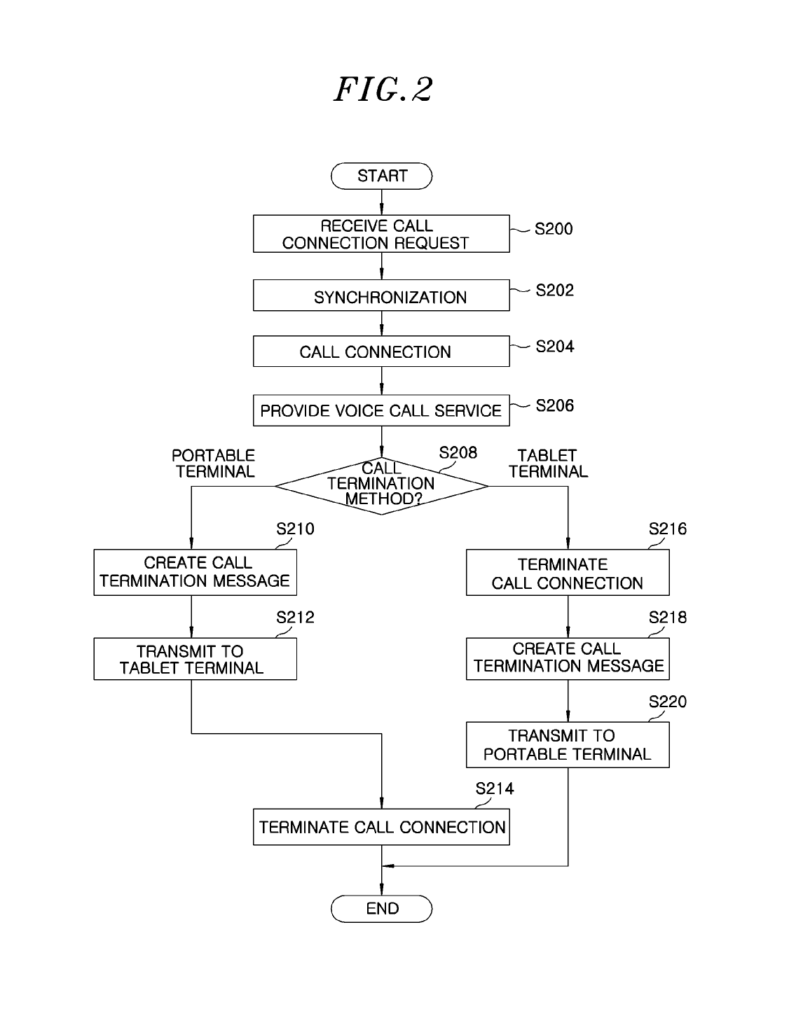

FIG. 2 is a flowchart illustrating a method for achieving a phone call function of a tablet terminal using a portable terminal in accordance with an embodiment of the present invention.

Referring to FIG. 2, when the tablet terminal 100 receives a request for a call connection from the other party on the wireless network 300 in step S200, the tablet terminal 100 starts communication with the short-range communication module 210 of the portable terminal 200 based on information set up in the short-range communication module 118. During the communication, the tablet terminal 100 transmits synchronization data to the portable terminal 200 and receives synchronization data generated in the synchronization module 212 of the portable terminal 200, thereby achieving synchronization between the portable terminal 200 and the tablet terminal 100 in step S202.

Next, the user of the tablet terminal 100 may respond to the call connection request by the use of the portable terminal 200, and a call connection is made between the telephone of the caller and the portable terminal linked with the tablet terminal 100 in step S204. Accordingly, voice signals are transmitted and received between the telephone of the caller and the portable terminal linked with the tablet terminal 100. More particularly, when voice signals of the other party is received by the tablet terminal 100, the tablet terminal 100 transmits the voice signals to the portable terminal 200 through the voice transmission module 114 and the voice transmission module 214 of the portable terminal 200 then sends the voice signals to the user interface 218, e.g., a speaker for outputting the voice signals.

In response to the voice signals from the other party, voice signals of the user may be generated by the user interface 218. The voice signals of the user are then transmitted to the tablet terminal 100.

The voice transmission module 114 of the tablet terminal 100 receives the voice signals from the portable terminal 200 and transmits the received voice signals to the other party on the wireless network 300, thereby achieving a voice call service between the other party and the user through the portable terminal 200 in step S206. That is, after the voice signals of the other party are received through the tablet terminal 100, the voice signals of the other party are outputted through the user interface 218 of the portable terminal 200, and the voice signals that are generated via the user interface 218 of the portable terminal 200 are transmitted to the other party through the tablet terminal 100.

A method for a call termination in step S208 may be performed as follows.

First, in case where the portable terminal 200 makes the call termination, the portable terminal 200 generates a call termination message in step S210, and then provides it to the tablet terminal 100 through the synchronization module 212 in step S212. Accordingly, the tablet terminal 100 terminates the call connection with the caller via the short-range communication module 110 in step S214.

On the other hand, in case where the tablet terminal 100 makes the call termination, the tablet terminal 100 terminates the call connection with the caller's terminal which is made through the wireless communication module 110 in step S216, creates a call termination message in step S218, and then provides call termination message to the portable terminal 200 through the synchronization module 112 in step S220. Accordingly, the call connection is terminated between the tablet terminal 100 and the portable terminal 200 while maintaining the linkage therebetween.

The embodiment of the present invention may also conduct a request for a call connection from the portable terminal 200 as follows.

First of all, the tablet terminal 100 determines whether or not a request for a call connection is received from the portable terminal 200. When the call connection request is received from the portable terminal 200, the tablet terminal 100 requests the call connection with a wireless network 300. After making the call connection with the wireless network 300, the tablet terminal 100 transmits voice signals generated by the portable terminal 200 to the wireless network 300 and transmitting voice signals received from the wireless network 300 to the portable terminal 200. Thereafter, upon terminating the call connection with the wireless network 300, the tablet terminal 100 terminates the communication with the portable terminal 200.

As set for the above, in accordance with the embodiments of the present invention, by providing the phone function of the tablet terminal by means of the portable terminal via communication between the tablet terminal and the portable terminal, it is possible to implement the phone function, which is inconvenient to use because of the weight and size of the tablet terminal, by the use of the portable terminal, and do an internet search, read e-books, or the like on a relatively large screen by the direct use of the tablet terminal, thereby increasing user convenience.

While embodiments have been shown and described, they are not limited thereto. It will be understood by those skilled in the art that various changes and modifications may be made without departing from the scope of the invention as defined in the following claims.

What is claimed is:

1. A tablet terminal comprising:
a wireless communication module configured to communicated with a wireless network;
a communication module configured to perform communication with a portable terminal;
a synchronization module configured to perform synchronization with the portable terminal when a request for a call connection is received from the wireless network through the wireless communication module; and
a voice transmission module configured to transmit voice signals provided from the wireless network to the portable terminal and transmit voice signals generated by the portable terminal to the wireless network through the wireless communication module.

2. The apparatus of claim 1, wherein the communication module performs communication with the portable terminal via short-range communication.

3. The apparatus of claim 1, wherein the tablet terminal further includes a data transmission module configured to transmit data provided from the wireless network to the portable terminal and sending data received from the portable terminal to the wireless network through the wireless communication module.

4. A portable terminal comprising:
a communication module configured to perform communication with a tablet terminal;
a synchronization module configured to perform synchronization with the tablet terminal when a request for a call connection is received from a wireless network through the tablet terminal; and
a voice transmission module configured to transmit voice signals generated by the portable terminal to the wireless network through the tablet terminal and transmit voice signals provided from the wireless network through the tablet terminal to a user interface for outputting thereof.

5. The apparatus of claim 4, wherein the communication module performs communication with the tablet terminal via short-range communication.

6. The apparatus of claim 4, wherein the portable terminal further includes a data transmission module configured to transmit data that is inputted via the user interface to the wireless network through the tablet terminal and transmit data received from the wireless network through the tablet terminal to the user interface.

7. A method of achieving a phone call function of a tablet terminal using a portable terminal, the method comprising:
when the tablet terminal receives a request for a call connection from a wireless network, performing synchronization with the portable terminal;
after making the call connection to the wireless network, transmitting voice signals received from the wireless network through the tablet terminal to the portable terminal and transmitting voice signals generated by the portable terminal to the wireless network through the tablet terminal; and
upon terminating the call connection with the wireless network, terminating the communication with the portable terminal.

8. The method of claim 7, wherein said terminating the communication with the portable terminal includes;
receiving a call termination message from the portable terminal;
receiving the call termination message, terminating the call connection with the wireless network; and
terminating the communication of the tablet terminal with the portable terminal.

9. The method of claim 7, wherein said terminating the communication with the portable terminal includes;
receiving a request for a call connection termination from the wireless network; and
terminating the call connection of the tablet terminal with the wireless network;
transmitting a call termination message to the portable terminal; and
terminating the communication of the tablet terminal with the portable terminal.

10. A method of achieving a phone call function of a tablet terminal using a portable terminal, the method comprising:
determining whether or not a request for a call connection is received from the portable terminal;
when the call connection request is received from the portable terminal, requesting for a call connection with a wireless network through the tablet terminal;
after making the call connection of the tablet terminal with the wireless network, transmitting voice signals generated by the portable terminal to the wireless network through the tablet terminal and transmitting voice signals received from the wireless network to the portable terminal; and
upon terminating the call connection of the tablet terminal with the wireless network, terminating the communication with the portable terminal.

11. The method of claim 10, wherein said terminating the communication with the portable terminal includes;
receiving a call termination message from the portable terminal; and
upon receiving the call termination message, terminating the call connection of the tablet terminal with the wireless network; and
terminating the communication of the tablet terminal with the portable terminal.

12. The method of claim 10, wherein said terminating the communication with the portable terminal includes:
receiving a request for a call connection termination request from the wireless network through the tablet terminal;
terminating the call connection of the tablet terminal with the wireless network;
transmitting a call termination message to the portable terminal; and
terminating the communication of the tablet terminal with the portable terminal.
